(19) United States
(12) Patent Application Publication
(10) Pub. No.: US 2009/0016816 A1
(43) Pub. Date: Jan. 15, 2009

(54) Connecting fitting for plates, particularly for shelves

(75) Inventor: Rudiger Walz, Neustetten (DE)

Correspondence Address: Friedrich Kueffner, Suite 910, 317 Madison Avenue, New York, NY, 10017, US

(73) Assignee: Hafele GmbH & Co. KG

(21) Appl. No.: 12/215,717

(22) Filed: Jun. 28, 2008

(30) Foreign Application Priority Data
Jul. 13, 2007 (DE) 20 2007 009 771.9

(51) Int. Cl. F16D 1/02

(52) U.S. Cl. 403/314

(57) ABSTRACT

A connecting fitting for plates, particularly for shelves, includes a mounting cup which can be placed into a recess of one of the plates which is open toward the surface thereof, a rotatably mounted tightening member, a stationary tightening bolt for the tensioning member and a support which can be screwed onto the surface of the other plate. The tightening member is arranged in the support and the tightening bolt in the mounting cup.

### BACKGROUND OF THE INVENTION

1. Field of the Invention

The present invention relates to a connecting fitting for plates, particularly for shelves. The fitting includes a mounting cup which can be placed into a recess of one of the plates which is open toward the surface thereof, a rotatably mounted tightening member, a stationary tightening bolt for the tightening member and a support which can be screwed onto the surface of the other plate.

2. Description of the Related Art

In fittings of this type, the tightening member is rotatably mounted in the mounting cup and interacts with a tightening bolt arranged at the support. However, the manufacture of individual pieces shaped in this manner poses certain difficulties.

### SUMMARY OF THE INVENTION

It is the object of the present invention to provide a connecting fitting of the above-described type which can be manufactured in a simple manner.

In accordance with the present invention, the above object is met by arranging the tightening member in the support and the tightening bolt in the mounting cup.

In accordance with another feature of the invention, the mounting cup has for securing the mounting cup in the recess of the mounting-plate, one or more locking springs cut from the circumference of the mounting cup. The locking springs are provided at their ends located opposite the pivoting axes thereof with bulges protruding into the interior of the mounting cup. When the support is inserted into the mounting cup, the mounting cup slides along the bulges and presses the locking springs outwardly into the material of the plates, so that the mounting cup is securely held in this manner.

In accordance with an advantageous feature, a transverse web is provided approximately at the lower end of the mounting cup, so that the mounting cup is mounted with greatest stability. In addition, the support is secured additionally against rotation by this transverse web when the support is shaped appropriately. In order to be able to place the support easily and to securely hold the support after it has been inserted, the mounting cup is provided with inclined insertion planes for the support and a subsequent locking edge for the support. The tightening bolt arranged in the mounting cup protrudes approximately perpendicularly from the wall and has a head at its free end.

In accordance with another feature of the invention, the support is constructed approximately as a sleeve which is externally flattened on one side, wherein in the flattened portion a recess is provided for the use of a holding means, particularly a screw. An outwardly bulging portion is provided opposite the recess to allow a tool to be passed through. In order to additionally secure the position of the support in the mounting cup, the latter is provided with a laterally protruding support edge by means of which it rests on the plate. A cover which is svivably provided on the support edge covers the tensioning member, so that the fitting has the appearance to the outside of a closed unit.

In accordance with an advantageous feature, the tightening member is constructed cylindrically and has a tightening slot extending over a portion of its circumference to allow engagement of the tightening bolt. In addition, the tightening member is provided at the upper end thereof with one or more slots for the engagement of a tool. Moreover, arranged on the support is an inner circumferential protrusion for locking means of the tightening member so that the latter is securely held in the support.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective view of an assembled connecting fitting;

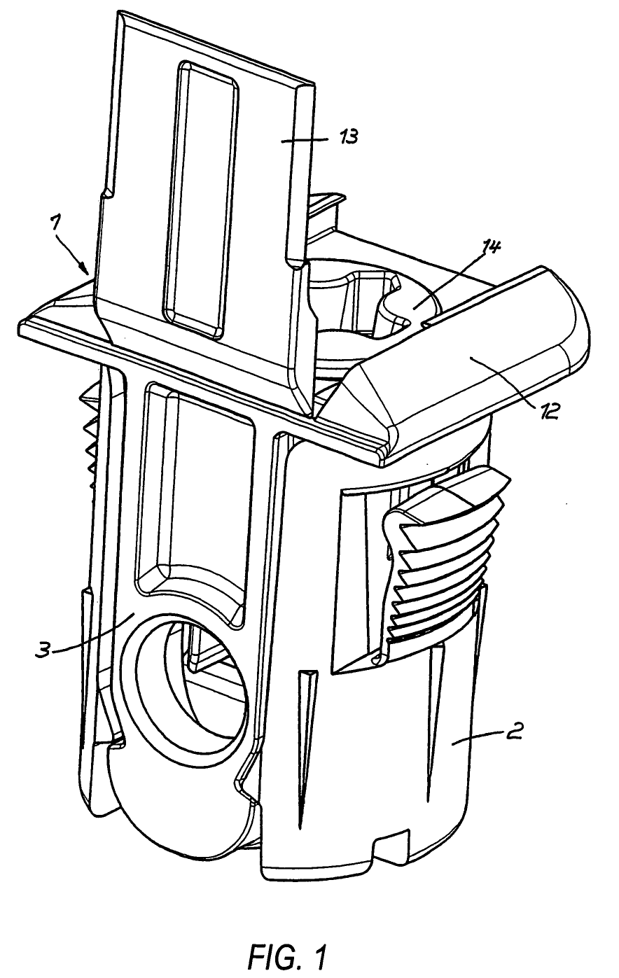

FIG. 2 is a perspective view of the mounting cup;

FIG. 3 is a perspective view of the support and the tightening member when the latter is placed into the support;

FIG. 4 is a perspective view of the tightening member;

FIG. 5. is a perspective view of the mounting cup, on a smaller scale, shown as it is placed in a plate;

FIG. 6 is a perspective view, on a smaller scale, of the support screwed onto a plate, with the tightening member being partially inserted; and

FIG. 7 is a perspective cross-sectional view, on a smaller scale, of two plates which are connected to each other by the connecting fitting.

### DETAILED DESCRIPTION OF THE INVENTION

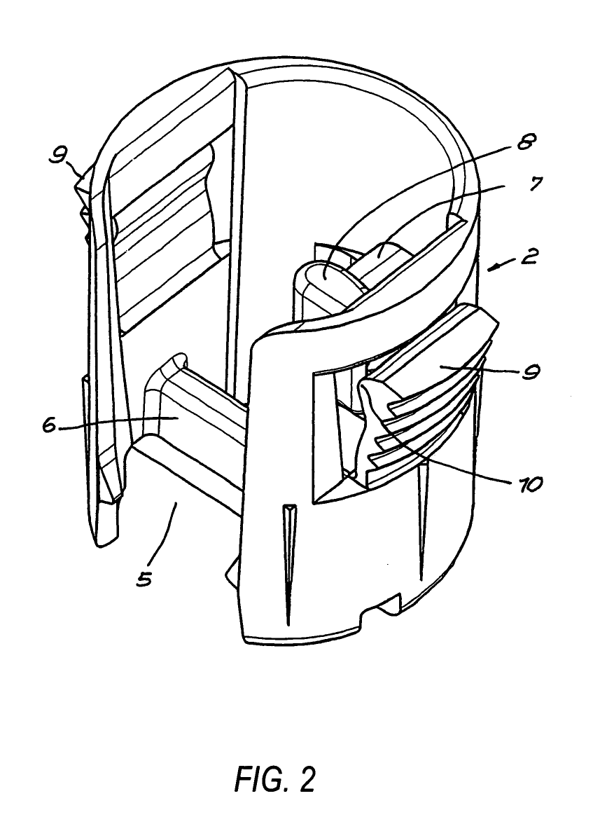

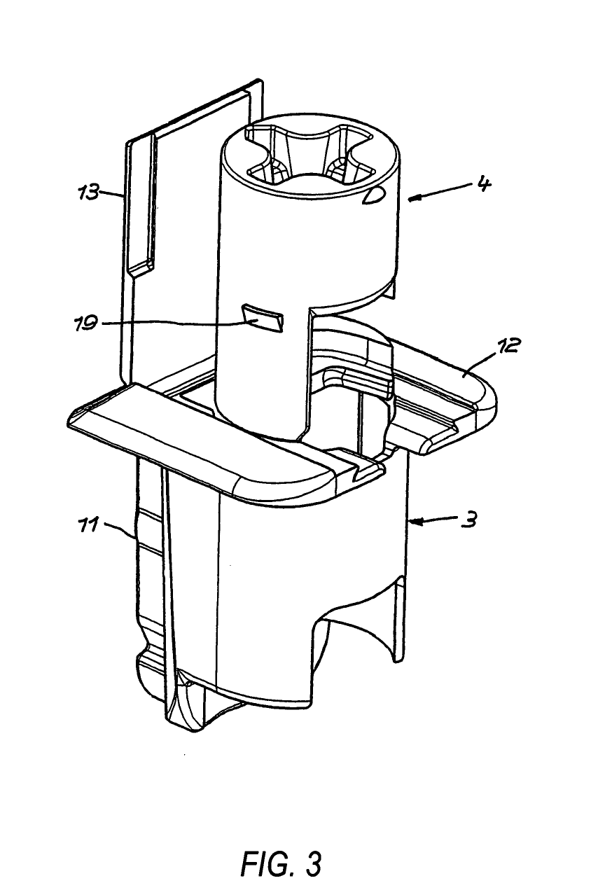

As illustrated in FIGS. 2-4, the connecting fitting 1 is composed of three parts, namely, the mounting cup 2, the support 3 and the tightening member 4.

The mounting cup 2 is sleeve-shaped and has an open portion 5. The mounting cup 2 is additionally provided in its lower area with a transverse web 6 in order to increase the stability. Also provided is a tightening bolt 7 which has a head 8 at the free end thereof. Outwardly pivotable locking springs 7 are provided on two oppositely located sides of the mounting cup 2, wherein the locking springs 9 have at their upper free ends inwardly protruding bulges 10.

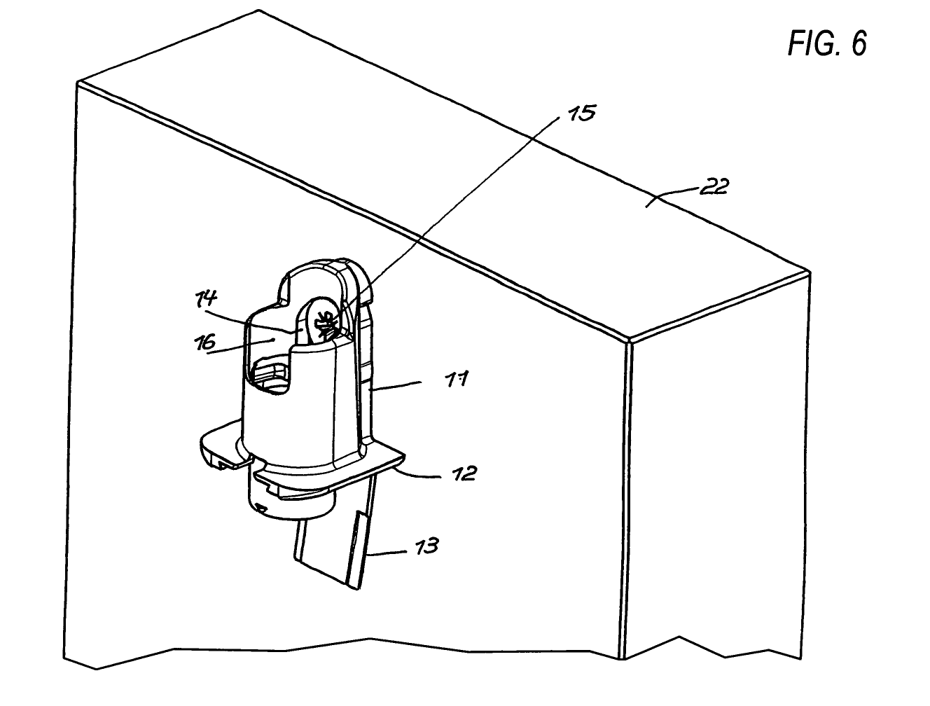

The support 3 is also sleeve-shaped, wherein, however, the support 3 has at its rear side a flattened portion 11. At its upper free end, a laterally protruding support edge 12 is arranged as well as a pivotable cover 13. As can be seen particularly in FIG. 6, a recess 14 for a fastening screw 15 is arranged in the flattened portion 11. Located opposite the fastening screw is an outward bulge 16 to be able to turn in the screw 15.

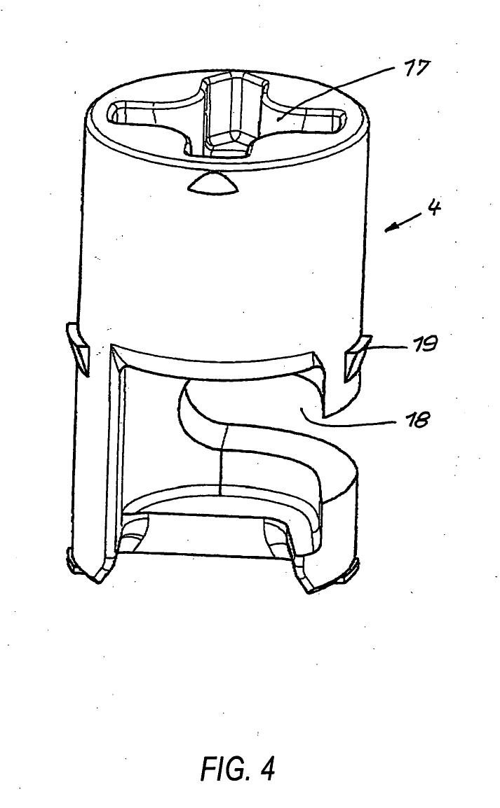

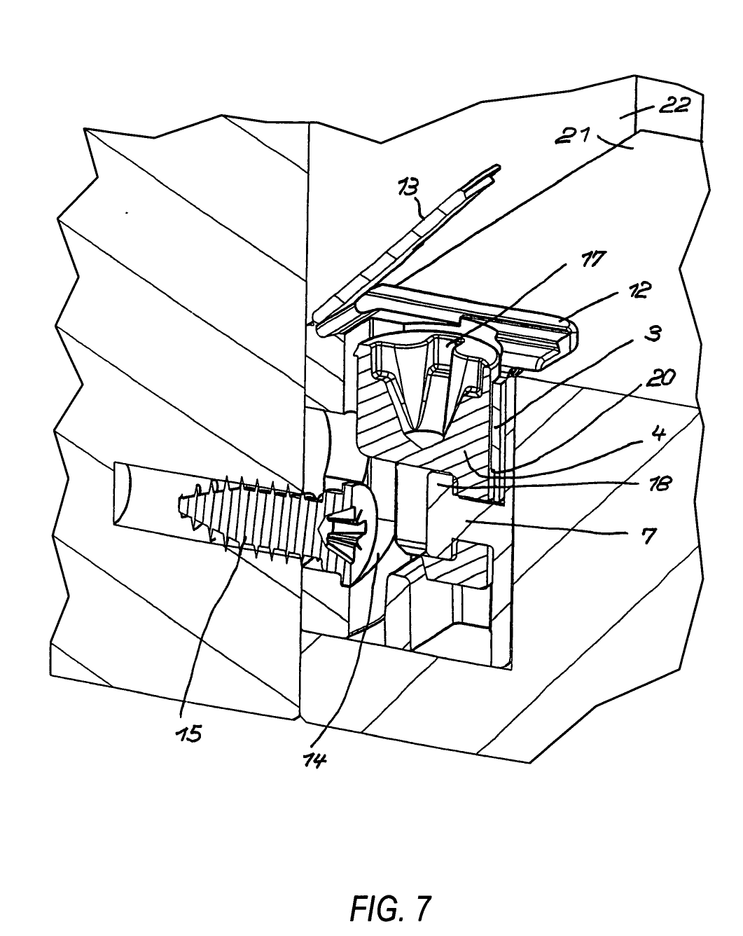

The cylindrically shaped tightening member 4 shown in FIG. 4 is at its upper end provided with a crossed-recess 17 for the engagement of a tool, not shown. A tightening slot 18 extends in the lower portion of the tightening member 4 over a portion of its circumference. As can be seen in FIG. 7, the tightening bolt 7 engages in the tightening slot 18. In addition, locking members 19 are provided at the circumference, wherein, after being inserted into the support 3, the locking members 19 engage in a circular circumferential projection 20 in order to secure the parts relative to each other.

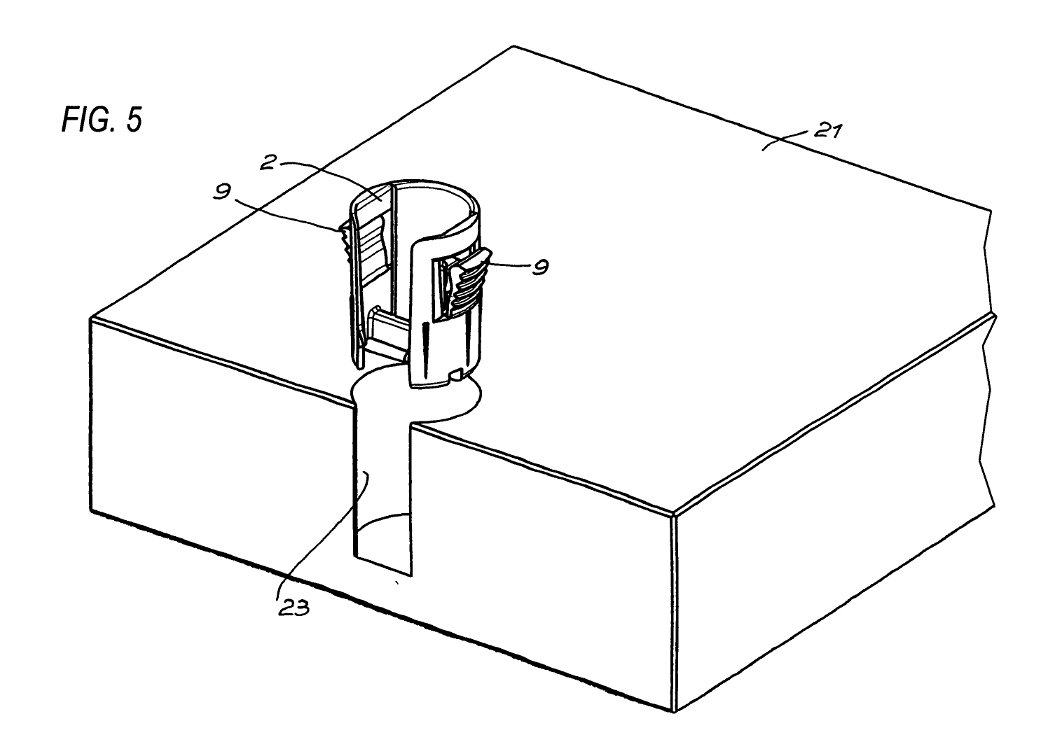

In order to connect the plates 21 and 22 in the configuration illustrated in FIG. 7, the mounting cup 2 is manually pressed into the recess 23 of the plate 21, as shown in FIG. 5. In the process, the two locking springs 9 pivot inwardly. Subsequently, the support 3 is screwed onto the plate 22, as shown in FIG. 6. Subsequently, the support 3 is inserted into the mounting cup 2. This causes the locking springs 9 to be pressed by the inwardly protruding bulges 10 toward the outside into the material of the plate 21, so that the mounting cup 2 is securely anchored. Subsequently, the tightening member 4 is inserted into the support 3 until the locking members 19 come to rest underneath the projection 20 of the support 3 and prevent an undesired removal of the tightening member 2. In this position, the tightening bolt 7 is located within the tightening slot 18, wherein the parts rest above and below the tightening bolt 7 against the head 18 thereof, so that, when the tightening member 2 is turned, the plates 21 and 22 are pressed firmly together. The interaction of the parts can be seen primarily from the illustration according to FIG. 7. This illustration also shows that, after the parts have been put together, the flap 13 can be pivoted onto the support edge 12 of the support 2 so that the crossed-recess 17 is completely covered to the outside.

While specific embodiments of the invention have been shown and described in detail to illustrate the inventive principles, it will be understood that the invention may be embodied otherwise without departing from such principles.

I claim:

1. A connecting fitting for plates, particularly for shelves, the fitting comprising a mounting cup adapted to be inserted into a recess of a first plate which is open toward a surface thereof, a rotatably mounted tightening member, a stationary tightening bolt for the tightening member, and a support adapted to be screwed onto a surface of a second plate, wherein the support is insertable into the mounting cup approximately in axial direction, wherein the tightening member is mounted in the support and the tightening bolt is mounted in the mounting cup.

2. The fitting according to claim 1, wherein the mounting cup comprises for securing the mounting cup in the recess of the first plate one or more pivotable locking springs cut from the circumference thereof.

3. The fitting according to claim 2, wherein the locking springs are provided at ends located opposite pivoting axes of the locking springs with bulges protruding into an interior of the mounting cup.

4. The fitting according to claim 1, wherein the mounting cup comprises a transverse web approximately at a lower end of the mounting cup.

5. The fitting according to claim 1, wherein the mounting cup has inclined insertion surfaces and an adjacent locking edge for the support.

6. The fitting according to claim 1, wherein the tightening bolt mounted in the mounting cup protrudes approximately perpendicularly from a wall of the tightening bolt, wherein the tightening bolt has at a free end thereof a head.

7. The fitting according to claim 1, wherein the support is a sleeve which is outwardly unilaterally flattened, wherein in a flattened portion a recess is provided for inserting a holding means, particularly a screw, and opposite the recess is provided a cutout for passing a tool therethrough.

8. The fitting according to claim 7, wherein the support has at an end thereof a laterally protruding support edge.

9. The fitting according to claim 8, wherein a cover is pivotably mounted on the support edge of the support.

10. The fitting according to claim 1, wherein the tightening member is cylindrically shaped and has a tightening slot extending over a portion of a circumference thereof for engagement of the tightening bolt.

11. The fitting according to claim 10, wherein the tightening member has one or more slots for engagement by a tool.

12. The fitting according to claim 1, wherein the support has on an inner side thereof a circumferentially extending step for locking means of the tightening member.
